(19) United States
(12) Patent Application Publication
(10) Pub. No.: US 2024/0253625 A1
(43) Pub. Date: Aug. 1, 2024

(54) INFORMATION PROCESSING APPARATUS

(71) Applicants: TOYOTA JIDOSHA KABUSHIKI KAISHA, Aichi-ken (JP); Matsuo Industries, Inc., Aichi Prefecture (JP)

(72) Inventors: Kohei MIWA, Shizuoka-ken (JP); Hayato MIZUMA, Tokyo-to (JP); Hiroshi KATO, Nagoya-shi (JP)

(21) Appl. No.: 18/424,866

(22) Filed: Jan. 29, 2024

(30) Foreign Application Priority Data
Jan. 30, 2023 (JP) 2023-011739

(51) Int. Cl. B60W 30/14; B60W 10/18; B60W 30/16; B60W 50/14

(52) U.S. Cl. CPC B60W 30/146; B60W 10/18; B60W 30/16; B60W 50/14; B60W 2050/143; B60W 2050/146; B60W 2554/80; B60W 2556/65

(57) ABSTRACT

Provided is a controller that is configured to perform: obtaining information about travel of a first vehicle; obtaining information about travel of a second vehicle; and outputting to the second vehicle information about the first vehicle giving way, and outputting a command for the first vehicle to take a give-way action, in response to determining, based on the information about the travel of the first vehicle and the information about the travel of the second vehicle, that predetermined conditions for the first vehicle to give way to the second vehicle are satisfied.

### CROSS REFERENCE TO THE RELATED APPLICATION

This application claims the benefit of Japanese Patent Application No. 2023-011739, filed on Jan. 30, 2023, which is hereby incorporated by reference herein in its entirety.

### BACKGROUND

### Technical Field

The present disclosure relates to an information processing apparatus.

### Description of the Related Art

It is known to present candidates for messages to be sent to the driver of a subject vehicle according to the relative relationship between the subject vehicle and an other vehicle, and to send a message selected by the subject vehicle driver from among the candidate messages to be sent to the other vehicle (see, for example, Patent Literature 1).

### CITATION LIST

### Patent Literature

Patent Literature 1: Japanese Patent Application Laid-Open Publication No. 2007-148524

### SUMMARY

The object of the present disclosure is to provide a technique to give way more smoothly.

One aspect of the present disclosure is directed to an information processing apparatus including a controller configured to perform:
obtaining information about travel of a first vehicle;
obtaining information about travel of a second vehicle; and
outputting to the second vehicle information about the first vehicle giving way, and outputting a command for the first vehicle to take a give-way action, in response to determining, based on the information about the travel of the first vehicle and the information about the travel of the second vehicle, that predetermined conditions for the first vehicle to give way to the second vehicle are satisfied.

In addition, another aspect of the present disclosure is directed to: an information processing method in which a computer performs the processing of the above-mentioned information processing apparatus; a program causing a computer to perform the above-mentioned processing; and a storage medium storing this program in a non-transitory manner.

According to the present disclosure, it is possible to provide a technique to give way more smoothly.

### BRIEF DESCRIPTION OF THE DRAWINGS

FIG. 1 is a view illustrating a schematic configuration of a driver-assistance system;

FIG. 2 is a block diagram schematically illustrating an example of a configuration of a vehicle constituting the driver-assistance system;

FIG. 3 is a view illustrating an example of a functional configuration of the vehicle; and

FIG. 4 is a flowchart of processing in a first vehicle at the time when the first vehicle gives way to a second vehicle.

### DESCRIPTION OF THE EMBODIMENTS

When vehicles give way to each other, messages may be exchanged between them. However, if it takes time to select appropriate messages, there may be a risk of missing an opportunity to give way. Also, there may be cases where messages are not noticed. Therefore, an information processing apparatus according to the present disclosure includes a controller that is configured to perform: obtaining information about travel of a first vehicle; obtaining information about travel of a second vehicle; and outputting to the second vehicle information about the first vehicle giving way, and outputting a command for the first vehicle to take a give-way action, in response to determining, based on the information about the travel of the first vehicle and the information about the travel of the second vehicle, that predetermined conditions for the first vehicle to give way to the second vehicle are satisfied.

The information about the travel of the first vehicle and the information about the travel of the second vehicle are, for example, information that can determine whether or not the situation will be such that the first vehicle will give way to the second vehicle. For example, the information about travel may be information that can determine whether or not the distance between the first vehicle and the second vehicle becomes closer than a predetermined distance. This predetermined distance is, for example, an appropriate inter-vehicle distance, and is a distance at which the first vehicle or the second vehicle does not need to slow down or change lanes. This appropriate inter-vehicle distance may be a value that changes according to the speed of the first vehicle or the second vehicle. For example, it is possible to grasp a future positional relationship between the first vehicle and the second vehicle based on the positions, the speeds, and the directions of travel of the first and second vehicles, and hence, the position, the speed, and the direction of travel of each vehicle may be included in the information about travel. In addition, as an alternative, it is possible to grasp the future positional relationship between the first vehicle and the second vehicle based on the estimated routes of the first vehicle and the second vehicle or the estimated positions thereof, and hence, the estimated route or position of each vehicle may be included in the information about travel.

Based on the information about the travel of the first vehicle and the information about the travel of the second vehicle, the controller can determine whether or not the predetermined conditions for the first vehicle to give way to the second vehicle are satisfied. The predetermined conditions for the first vehicle to give way to the second vehicle includes a condition for whether or not the first vehicle needs to give way to the second vehicle, and a condition for whether or not the first vehicle can smoothly give way to the second vehicle. For example, in cases where the distance between the first vehicle and the second vehicle becomes less than a predetermined distance which is an appropriate inter-vehicle distance if the first vehicle does not give way to the second vehicle, the first vehicle can slow down so as to give way to the second vehicle, thereby making it possible to take an appropriate inter-vehicle distance between the first vehicle and the second vehicle. On the other hand, if the distance between the first vehicle and the second vehicle is farther (greater) than the appropriate inter-vehicle distance, it is determined that the conditions for giving way are not satisfied because there is no need to give way in the first place. In addition, if the first vehicle cannot give way to the second vehicle without applying a sudden brake, it may hinder the smooth travel of the first vehicle and its surrounding vehicles, and hence, it is determined that the conditions for giving way is not satisfied. Thus, the controller may determine whether or not the first vehicle needs to give way to the second vehicle, and whether or not the first vehicle can give way to the second vehicle in a smooth manner.

Then, in response to the fact that the predetermined conditions are satisfied, the controller outputs to the second vehicle information about the first vehicle giving way. Upon receiving this information, the second vehicle may, for example, display a message or play a voice to inform the driver of the second vehicle that the first vehicle will give way. Thus, there is no need for the driver of the second vehicle to send a message to the first vehicle, nor for the driver of the first vehicle to send a message to the second vehicle. Since the second vehicle is informed from the first vehicle that the first vehicle will give way to the second vehicle without any operation by the drivers of both vehicles, the driver of the second vehicle can quickly learn that the first vehicle is giving way.

Further, the controller outputs a command for the first vehicle to take a give-way action. The give-way action is an action to give way and includes, for example, slowing down and changing lanes. By outputting the command to take the give-way action, the first vehicle gives way to the second vehicle without the driver of the first vehicle being aware of it. Therefore, it is possible to suppress the loss of opportunities to give way due to delays in the driver's operation.

Hereinafter, embodiments of the present disclosure will be described based on the accompanying drawings. The configurations of the following embodiments are examples, and the present disclosure is not restricted to the configurations of the embodiments.

### First Embodiment

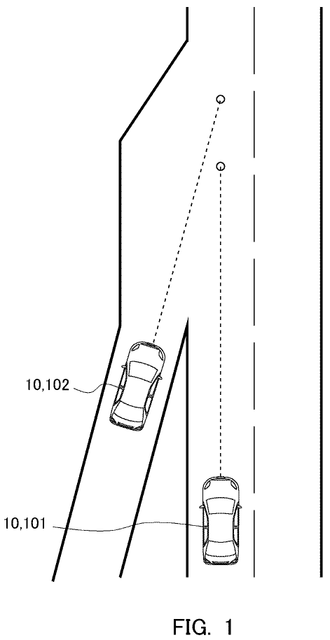

FIG. 1 is a view illustrating a schematic configuration of a driver-assistance system 1 according to a first embodiment. In FIG. 1, there are illustrated a first vehicle 101 and a second vehicle 102. Hereinafter, in cases where the first vehicle 101 and the second vehicle 102 are not distinguished from each other, they are each simply referred to as a vehicle 10. The vehicle 10 is, for example, a connected car, and is a vehicle capable of making vehicle-to-vehicle communication (V2V). Further, the vehicle 10 is a vehicle equipped with an advanced driver-assistance system (ADAS) that is capable of automatically operating the brakes without the driver's operation.

In FIG. 1, a lane in which the first vehicle 101 is traveling is referred to as a main lane, and a lane in which the second vehicle 102 is traveling is referred to as a merge lane that joins the main lane. The second vehicle 102 is a vehicle 10 that is about to enter the main lane from the merge lane. In the state illustrated in FIG. 1, when the second vehicle 102 enters the main lane, it will enter slightly ahead of the first vehicle 101. In this case, the driver of the second vehicle 102 needs to determine whether if the second vehicle 102 can enter ahead of the first vehicle 101. For example, if it is determined that the inter-vehicle distance to the first vehicle 101 is too short when the second vehicle 102 enters the main line, the driver of the second vehicle 102 will consider to brake and enter behind the first vehicle 101.

Here, for example, messages may be sent between the driver of the first vehicle 101 and the driver of the second vehicle 102 to confirm their intentions. However, because of the time required to exchange messages, it may not be possible to confirm the intention of the driver of the first vehicle 101 before the second vehicle 102 enters the main lane.

On the other hand, when the second vehicle 102 merges from the merge lane into the main lane, the first vehicle 101 according to the present embodiment determines whether or not it is possible to give way to the second vehicle 102 (give-way action), and if it is determined possible, the first vehicle 101 takes the give-way action and notifies the second vehicle 102 to the effect that it will give way. By the first vehicle 101 taking the give-way action, for example, automatic braking is activated to slow down the first vehicle 101, so that the second vehicle 102 can enter in front of the first vehicle 101 without difficulty.

Each of the vehicles 10 generates a course prediction, and transmits it to other vehicles 10 therearound by means of vehicle-to-vehicle communication. In addition, the course prediction includes information indicating a combination of the future positions and time points of each vehicle 10. The course prediction may be indicated by a line connecting the future positions of each vehicle 10 in order of time. The course prediction is generated in each vehicle 10 based on, for example, the direction of travel and the speed of each vehicle 10, and is transmitted to the other vehicles 10. The course prediction is generated, for example, on the assumption that the direction of travel and the speed of each vehicle 10 at the current point in time are maintained. The course prediction in each vehicle 10 may include information about a future travel route (hereinafter, also referred to as an estimated route) of each vehicle 10. Map information may be used to generate the estimated route. That is, the estimated route may be generated such that each vehicle 10 travels on roads included in a map.

In FIG. 1, the estimated route of each vehicle 10 is indicated by a dashed line connecting a white circle mark in front of the vehicle 10 and the vehicle 10. The white circle mark is a position in future (hereinafter, also referred to as a future position) of each vehicle 10 included in the course prediction generated by the vehicle 10. The future position of each vehicle 10 may be the position of the vehicle 10 after a predetermined period of time. In addition, future positions may be a plurality of positions (locations) at predetermined time intervals.

When the first vehicle 101 receives a course prediction from an other vehicle 10, it identifies, as a second vehicle 102, the other vehicle 10 that transmitted the course prediction. Then, it is determined in the first vehicle 101 whether or not predetermined conditions for giving way are satisfied, based on the course prediction of the first vehicle 101 and the course prediction of the second vehicle 102.

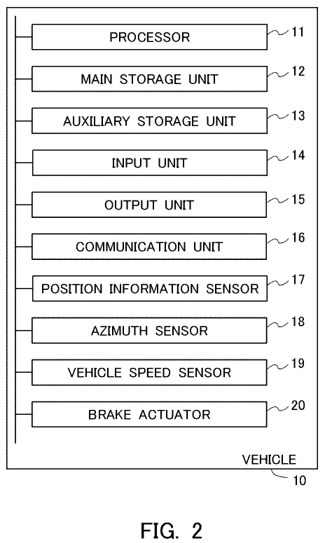

FIG. 2 is a block diagram schematically illustrating an example of the configuration of each of the vehicles 10 constituting the driver-assistance system 1. This configuration is common to the first vehicle 101 and the second vehicle 102. The vehicle 10 includes a processor 11, a main storage unit 12, an auxiliary storage unit 13, an input unit 14, an output unit 15, a communication unit 16, a position information sensor 17, an azimuth sensor 18, a vehicle speed sensor 19, and a brake actuator 20. These components are mutually connected to one another by means of a bus. The processor 11 is a CPU (Central Processing Unit), a DSP (Digital Signal Processor), or the like. The processor 11 is an example of a controller.

The main storage unit 12 is a RAM (Random Access Memory), a ROM (Read Only Memory), or the like. The auxiliary storage unit 13 is an EPROM (Erasable Programmable ROM), a hard disk drive (HDD), a removable medium, or the like. The auxiliary storage unit 13 stores an operating system (OS), various programs, various tables, and the like. The processor 11 loads a program stored in the auxiliary storage unit 13 into a work area of the main storage unit 12 and executes the program, so that each component or the like is controlled through the execution of the program. The main storage unit 12 and the auxiliary storage unit 13 are computer readable recording media.

The input unit 14 is a means or unit that receives an input operation performed by a user, and is, for example, a touch panel, a keyboard, a mouse, a push button, or the like. The output unit 15 is a means or unit that serves to present information to the user, and is, for example, an LCD (Liquid Crystal Display), an EL (Electroluminescence) panel, a speaker, a lamp, or the like. The input unit 14 and the output unit 15 may be configured as a single touch panel display (hereinafter, also simply referred to as a display). The communication unit 16 is a means or unit that performs vehicle-to-vehicle communication. The communication unit 16 is, for example, a circuit for communicating with other vehicles 10.

The position information sensor 17 obtains position information (e.g., latitude and longitude) of the vehicle 10 at a predetermined cycle. The position information sensor 17 is, for example, a GPS (Global Positioning System) receiver unit, a wireless LAN communication unit, or the like. The information obtained by the position information sensor 17 is recorded, for example, in the auxiliary storage unit 13 or the like. The azimuth sensor 18 obtains an azimuth in which the vehicle 10 faces, at predetermined intervals. The azimuth sensor 18 includes, for example, a geomagnetic sensor, a gyro sensor, or the like. The information obtained by the azimuth sensor 18 is recorded, for example, in the auxiliary storage unit 13 or the like. The vehicle speed sensor 19 is a sensor that detects the speed of the vehicle 10. The information obtained by the vehicle speed sensor 19 is stored, for example, in the auxiliary storage unit 13 or the like. The brake actuator 20 is an actuator for changing a braking force acting on the vehicle 10.

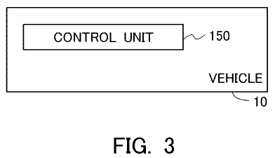

Next, FIG. 3 is a view illustrating an example of a functional configuration of the vehicle 10. The vehicle 10 includes a control unit 150 as its functional component. The control unit 150 is, for example, a functional component provided by the processor 11 of the vehicle 10 executing various programs stored in the auxiliary storage unit 13.

The control unit 150 generates information about course prediction, and transmits it to other vehicles 10. The course prediction includes a future position or an estimated route. For example, assuming that the speed and the direction of travel of the vehicle 10 at the current point in time are maintained, the control unit 150 generates the future position by estimating the position of the vehicle 10 after a predetermined period of time. In addition, the estimated route is generated by connecting the current position to the future position by a straight line. The estimated route may include information about the time point at which the vehicle 10 is estimated to pass through each point on the estimated route. The information about the course prediction may include information about the speed of the vehicle 10, information about the position thereof, or information about the direction of travel thereof, at the current point in time. Each vehicle 10 transmits the current location and the course prediction of the vehicle 10 to other vehicles 10 in association with its vehicle ID. At this time, the information about the speed of the vehicle 10 and the direction of travel of the vehicle 10 at the current point in time may also be transmitted together to the other vehicles 10. Here, note that, as an alternative, for example, information capable of generating a course prediction (e.g., information about position, speed, and direction of travel) may be transmitted by the control unit 150 to the other vehicles 10. Then, the vehicles 10 that have received this information may each generate a course prediction. The course prediction, the information about the current speed of each vehicle 10, the information about the current position, and the information about the current direction of travel are examples of the information about the travel of the vehicle. In addition, upon receiving the information about the course prediction from an other vehicle 10, the control unit 150 stores the information in the auxiliary storage unit 13.

The control unit 150 determines, based on the course prediction of the other vehicle 10, whether or not the predetermined conditions for giving way to the other vehicle 10 are satisfied.

Based on the course prediction received from the other vehicle 10 and the course prediction of the subject (own) vehicle, the control unit 150 determines that the predetermined conditions for giving way are satisfied when both of the vehicles 10 are within a predetermined distance at the same point in time and the subject vehicle can give way by decelerating at a predetermined decelerating acceleration (i.e., negative acceleration) or less. In response to this determination, the subject vehicle takes a give-way action.

The control unit 150 of the first vehicle 101 transmits a notification to the second vehicle 102 that it will give way. The control unit 150 of the second vehicle 102, which has received this notification, notifies the driver of the second vehicle 102 that the first vehicle 101 will give way by displaying, for example, a phrase “Please go ahead” on the display, or by playing, for example, a voice “Please go ahead” from the speaker.

In addition, the control unit 150 of the first vehicle 101 decelerates the first vehicle 101 by transmitting a command to the brake actuator 20. Here, note that, as an alternative, the first vehicle 101 may be decelerated by engine braking or regenerative braking, or the first vehicle 101 may be decelerated by using both the engine braking and the regenerative braking in combination. At this time, the first vehicle 101 is decelerated at the predetermined decelerating acceleration or less so as to prevent sudden braking. Note that in cases where the first vehicle 101 cannot give way to the second vehicle 102 unless the decelerating acceleration is higher than the predetermined decelerating acceleration, the first vehicle 101 does not take the give-way action because the predetermined conditions for giving way are not satisfied. The predetermined decelerating acceleration is a decelerating acceleration that does not result in sudden braking, and has been stored in the auxiliary storage unit 13.

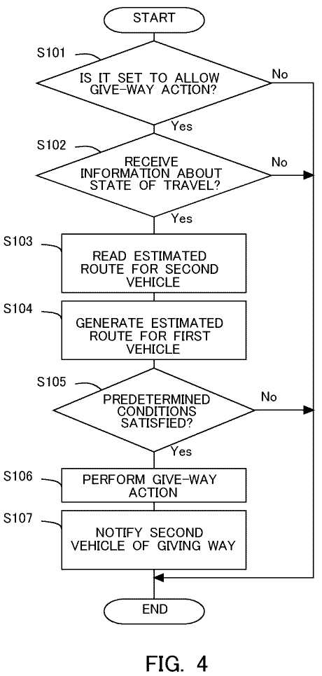

Next, the flow of processing in the first vehicle 101 when the first vehicle 101 gives way to the second vehicle 102 will be described. FIG. 4 is a flowchart of the processing or routine in the first vehicle 101 at the time when the first vehicle 101 gives way to the second vehicle 102. This routine is executed by the control unit 150 at predetermined time intervals.

In step S101, the control unit 150 determines whether or not the setting is such that a give-way action is allowed. In this embodiment, whether or not to take a give-way action can be set by the driver of the first vehicle 101 in advance. For example, by operating a slide switch displayed on the touch panel in advance, the driver can switch whether or not to allow give-way driving to be executed when the predetermined conditions are satisfied. With the setting made by the driver himself or herself, it can be considered that the driver himself or herself permits the first vehicle 101 to decelerate when the give-way driving is performed. When an affirmative determination is made in step S101, the processing or routine proceeds to step S102, whereas when a negative determination is made, this routine is ended.

In step S102, the control unit 150 determines whether or not information about the travel of the second vehicle 102 has been received from the second vehicle 102. This information about the travel includes information about the course prediction of the second vehicle 102 or information about each of the position, the speed, and the direction of travel of the second vehicle 102. These pieces of information are stored in the auxiliary storage unit 13 of the first vehicle 101. When an affirmative determination is made in step S102, the processing or routine proceeds to step S103, whereas when a negative determination is made, this routine is ended.

In step S103, the control unit 150 reads, for example, the estimated route of the second vehicle 102. Note that if the information received from the second vehicle 102 does not include its estimated route, the control unit 150 of the first vehicle 101 may generate an estimated route for the second vehicle 102 based on information about the position, the vehicle speed, and the direction of travel of the second vehicle 102. In step S104, the control unit 150 generates an estimated route for the first vehicle 101. The control unit 150 generates the estimated route of the first vehicle 101 based on information about the position, the vehicle speed, and the direction of travel of the first vehicle 101.

In step S105, the control unit 150 determines whether or not the predetermined conditions for the first vehicle 101 to give way to the second vehicle 102 are satisfied. For example, when the following conditions (1) and (2) are both satisfied, the control unit 150 determines that the predetermined conditions are satisfied, whereas when at least one of the conditions is not satisfied, the control unit 150 determines that the predetermined conditions are not satisfied.
(1) The distance between the position of the first vehicle 101 on the estimated route and the position of the second vehicle 102 on the estimated route at the same point in time is less than the predetermined distance.
(2) Even if the decelerating acceleration of the first vehicle 101 is made equal to or less than the predetermined decelerating acceleration, the first vehicle 101 can give way to the second vehicle 102.

The condition (1) is determined by calculating the distance between both the vehicles 10 at predetermined time intervals based on the estimated routes of both the vehicles 10, and comparing this distance with the predetermined distance. The condition (2) is determined, for example, by calculating whether or not the distance between the first vehicle 101 and the second vehicle 102 can be maintained equal to or greater than the predetermined distance when the first vehicle 101 decelerates at the predetermined decelerating acceleration. When an affirmative determination is made in step S105, the processing or routine proceeds to step S106, whereas when a negative determination is made, this routine is ended. That is, when the predetermined conditions are not satisfied, the give-way action is not performed. Here, note that, as an alternative, whether or not the predetermined conditions are satisfied may be determined by using a machine learning model. For example, the machine learning model may be generated that outputs an answer as to whether or not the predetermined conditions for the first vehicle 101 to give way to the second vehicle 102 are satisfied, when information about the travel of the first vehicle 101 and information about the travel of the second vehicle 102 are input.

In step S106, the control unit 150 performs the give-way action. That is, for example, when the second vehicle 102 enters the main lane from the merge lane, the control unit 150 decelerates the first vehicle 101 so that the distance between the second vehicle 102 and the first vehicle 101 is equal to or greater than a predetermined inter-vehicle distance. At this time, the control unit 150 outputs a command to the brake actuator 20 to apply the brakes so that the decelerating acceleration of the first vehicle 101 is made to equal to or less than the predetermined decelerating acceleration. In addition, the control unit 150 may generate a command to output from the output unit 15 of the first vehicle 101 that the give-way action has been taken. For example, the control unit 150 may notify the driver of the first vehicle 101 by displaying characters on the display, which is the output unit 15 of the first vehicle 101, or by playing a voice from the speaker. By taking the give-way action, automatic braking is activated in the first vehicle 101, so there is a risk that the driver, who is unaware of the situation, may step on the accelerator or feel suspicious. On the other hand, if the driver is notified that the give-way action will be taken, the give-way action can be performed smoothly.

In step S107, the control unit 150 notifies the second vehicle 102 of the fact that the first vehicle 101 will give way. This notification includes, for example, a command to display on the display of the second vehicle 102 characters that represent “giving way”, or a command to play a voice to give way from the speaker of the second vehicle 102.

As explained above, according to this embodiment, when the predetermined conditions for the first vehicle 101 to give way to the second vehicle 102 are satisfied, the first vehicle 101 takes the give-way action without any operation by the driver. Therefore, there will be more opportunities for the second vehicle 102 to be given way. In addition, the second vehicle 102 is notified that it will be given way, thus making it easier for the driver of the second vehicle 102 to enter in front of the first vehicle 101.

### Other Embodiments

The above-described embodiments are merely examples, but the present disclosure can be implemented with appropriate modifications without departing from the spirit thereof. The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

In the above-described embodiment, vehicles 10 directly communicate with one another through vehicle-to-vehicle communication, but instead of this, communication may be performed via communication means provided on a road. In addition, each vehicle 10 may communicate with other vehicles 10 via a server. In the above-mentioned embodiment, it is determined whether or not the predetermined conditions for giving way is satisfied in each vehicle 10, but this determination may be made by an external server. In this case, for example, each vehicle 10 transmits information about travel to the server at predetermined time intervals. The server may then generate a course prediction for each vehicle, and determine whether or not the predetermined conditions for the first vehicle 101 to give way to the second vehicle 102 are satisfied. Then, in response to the predetermined conditions being satisfied, the server may transmit a command to the first vehicle 101 to take a give-way action, and notify the second vehicle 102 that the first vehicle 101 will give way to the second vehicle 102.

In addition, in the above-mentioned embodiment, the give-way action in the case where a vehicle 10 merges from the merge lane into the main lane has been described, but the present disclosure is not limited to this, and can be similarly applied to the case of giving way in other situations. For example, in cases where the first vehicle 101 is traveling straight ahead and the second vehicle 102 is turning right at an intersection, the present disclosure can also be applied to the case where the first vehicle 101 is decelerated to give way to the second vehicle 102 to allow it to turn right. Similarly, the present disclosure can be applied to the case where the second vehicle 102 turns right to enter a parking lot of a store or like from a road. Also, the present disclosure can be applied to the case where the second vehicle 102 enters a road from a parking lot of a store or the like outside the road. Further, the present disclosure can also be applied to the case where the second vehicle 102 changes its course to enter the lane in front of the first vehicle 101 on a road with a plurality of lanes.

Moreover, an incentive may be given to the driver of the first vehicle 101 that has given way. For example, after notifying the second vehicle 102 of the fact that the first vehicle 101 will give way in step S107 of FIG. 4, information to that effect may be transmitted to the external server. Based on this information, the server may generate an incentive and transmit it to the first vehicle 101. As an alternative, the second vehicle 102 may transmit an incentive to the first vehicle 101. The incentive may be, for example, a coupon that reduces the toll for the first vehicle 101 on the expressway on which the first vehicle 101 is traveling. In addition, the incentive may be transmitted to the terminal of the driver associated with the first vehicle 101.

Further, it may be determined whether or not the predetermined conditions for the first vehicle 101 to give way to the second vehicle 102 are satisfied, by using, as a trigger, the execution of a predetermined action by the driver of the second vehicle 102. For example, when the driver of the second vehicle 102 makes a predetermined input to the input unit 14 in the second vehicle 102, information indicating a request to give way may be broadcast from the second vehicle 102. The first vehicle 101, which has received this information, may determine whether or not the predetermined conditions are satisfied, and take a give-way action. The predetermined action to be taken by the driver of the second vehicle 102 includes making a predetermined utterance or pressing a predetermined button. Information about whether or not the driver of the second vehicle 102 has performed the predetermined action may be transmitted together with information about the state of traveling, for example. Thus, for example, in step S102 of FIG. 4, instead of determining whether or not information about the state of traveling has been received, the control unit 150 may determine whether or not information about the state of traveling and information about whether or not the driver of the second vehicle 102 performed the predetermined action have been received.

In addition, the predetermined action to be taken by the driver of the second vehicle 102 may include operating a direction indicator. That is, the control unit 150 of the first vehicle 101 may determine whether or not the predetermined conditions are satisfied for an other vehicle 10, for example, by using, as a trigger, the fact that a direction indicator has blinked in the other vehicle 10. As an alternative, the driver of the second vehicle 102 may operate a direction indicator, whereby the control unit 150 of the second vehicle 102 may generate a course prediction so as to cause the second vehicle 102 to head in that direction. According to this course prediction, the control unit 150 of the first vehicle 101 may determine whether or not the predetermined conditions are satisfied.

Further, in cases where the predetermined conditions for the first vehicle 101 to give way to the second vehicle 102 are satisfied, information about the characteristics of the second vehicle 102 may be transmitted to the first vehicle 101. Similarly, information about the characteristics of the first vehicle 101 may be transmitted to the second vehicle 102. Here, if there are also vehicles 10 in front of and behind the first vehicle 101, the driver of the second vehicle 102 may not be able to determine which vehicle 10 has given way. On the other hand, if the characteristics of the first vehicle 101 are notified to the driver of the second vehicle 102, the driver of the second vehicle 102 can determine which vehicle 10 has given way, and thus can determine which vehicle 10 to enter in front of. Therefore, the second vehicle 102 can smoothly enter the lane in front of the first vehicle 101. Also, by notifying the driver of the first vehicle 101 of the characteristics of the second vehicle 102, it becomes possible for the driver of the first vehicle 101 to determine which vehicle 10 to give way to when the first vehicle 101 slows down due to automatic braking, thus enabling the driver of the first vehicle 101 to give way smoothly. As the characteristics of each vehicle 10, there can be mentioned, for example, the color of the vehicle, the name of the vehicle, and the shape of the vehicle. The characteristics of the own or subject vehicle 10 may have been stored in advance in the auxiliary storage unit 13, and may be transmitted by being included in the information about travel. As a result, the control unit 150 of the first vehicle 101 can grasp the characteristics of the second vehicle 102, for example, in step S102 of FIG. 4. On the other hand, the characteristics of the first vehicle 101 may be transmitted, for example, when notifying that the first vehicle 101 will give way in step S107 of FIG. 4. The characteristics about the first vehicle 101 or the characteristics about the second vehicle 102 are output from the output unit 15 of the first or second vehicle 101 or 102. For example, the characteristics about each vehicle 10 may be played by voice from a speaker. For example, a voice such as “A black sedan gives way.”, “Please give way to a red SUV.” or the like may be played from the speaker.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to perform:
obtaining information about travel of a first vehicle;
obtaining information about travel of a second vehicle; and
outputting to the second vehicle information about the first vehicle giving way, and outputting a command for the first vehicle to take a give-way action, in response to determining, based on the information about the travel of the first vehicle and the information about the travel of the second vehicle, that predetermined conditions for the first vehicle to give way to the second vehicle are satisfied.

2. The information processing apparatus according to claim 1, wherein
the controller notifies a driver of the first vehicle about taking the give-way action when the first vehicle takes the give-way action.

3. The information processing apparatus according to claim 1, wherein
the controller notifies a driver of the first vehicle of characteristics of the second vehicle when the first vehicle takes the give-way action.

4. The information processing apparatus according to claim 1, wherein
the controller includes information about characteristics of the first vehicle in the information about that the first vehicle gives way.

5. The information processing apparatus according to claim 1, wherein
the predetermined conditions include an ability to maintain a distance between the first vehicle and the second vehicle at a predetermined distance or more by decelerating the first vehicle at a predetermined decelerating acceleration or less; and
the controller outputs, as the command for the first vehicle to take the give-way action, a command for applying a brake so that the decelerating acceleration of the first vehicle is equal to or less than the predetermined decelerating acceleration.
